(19) United States
(12) Patent Application Publication
(10) Pub. No.: US 2020/0200560 A1
(43) Pub. Date: Jun. 25, 2020

(54) DRIVING ASSISTANCE DEVICE, VEHICLE, INFORMATION PROVISION DEVICE, DRIVING ASSISTANCE SYSTEM, AND DRIVING ASSISTANCE METHOD

(71) Applicant: TOYOTA JIDOSHA KABUSHIKI KAISHA, Toyota-shi (JP)

(72) Inventors: Takuro YANAGI, Toyota-shi (JP); Maki TAMURA, Nisshin-shi (JP); Mutsumi MATSUURA, Okazaki-shi (JP); Toshihiko INOUE, Toyota-shi (JP); Naoki YAMAMURO, Nagoya-shi (JP); Takashi HAYASHI, Aichi-gun (JP); Takahiro SHIGA, Chiryu-shi (JP)

(73) Assignee: TOYOTA JIDOSHA KABUSHIKI KAISHA, Toyota-shi (JP)

(21) Appl. No.: 16/690,230

(22) Filed: Nov. 21, 2019

(30) Foreign Application Priority Data
Dec. 21, 2018 (JP) 2018-240115

(51) Int. Cl. G01C 21/36; G06F 3/01; G06K 9/00; H04N 5/232

(52) U.S. Cl. CPC G01C 21/3626; H04N 5/23218; G06K 9/00791; G06F 3/013

(57) ABSTRACT

A driving assistance device includes a control unit that acquires event position information and an object image, and presents the acquired object image to a driver who is driving toward a position indicated in the acquired event position information. The event position information is position information of a vehicle at the time when a fact that a first object is confused with a second object, existing on the same road as the first object, is detected as an event in the vehicle, and the object image is an image captured from the vehicle and including the second object.

### INCORPORATION BY REFERENCE

The disclosure of Japanese Patent Application No. 2018-240115 filed on Dec. 21, 2018 including the specification, drawings and abstract is incorporated herein by reference in its entirety.

### BACKGROUND

### 1. Technical Field

The present disclosure relates to a driving assistance device, a vehicle, an information provision device, a driving assistance system, and a driving assistance method.

### 2. Description of Related Art

Japanese Unexamined Patent Application No. 2008-064483 (JP 2008-064483 A) discloses a technology which calculates a mistake probability that a user's travel route deviates from a scheduled travel route at an intersection is requested based on travel history information, and performs route guidance according to the user's mistake probability when the user's vehicle passes the intersection.

### SUMMARY

When a plurality of signals is lined up in a travel direction of a vehicle, or when the plurality of signals are facing a similar direction at a complicated intersection, it is difficult for a driver to recognize the signal he or she should follow and the driver often follows a wrong signal. When the driver is driving on a highway or an unfamiliar road, a user may confuse branches or intersections even though the user is using a navigation function.

In the technology described in JP 2008-064483 A, when the mistake probability is higher than a reference probability, route guidance, such as “300 m ahead, turn left at an intersection with a corner gas station”, is provided, which is more detailed than normal route guidance, such as “300 m ahead, turn left at the intersection”. However, it is not always easy to understand the detailed route guidance. Specifically, at the complicated intersection, the detailed route guidance may rather cause confusion. At an intersection without any sign, providing the detailed route guidance itself is difficult.

The purpose of the present disclosure is to make it difficult for a driver to confuse objects existing on a road.

A driving assistance device according to an embodiment of the present disclosure includes a control unit that acquires event position information and an object image, and presents the acquired object image to a driver who is driving toward a position indicated in the acquired event position information. The event position information is position information of the vehicle at the time when a fact that a first object is confused with a second object, existing on the same road as the first object, is detected as an event in the vehicle, and the object image is an image captured from the vehicle and including the second object.

An information provision device according to an embodiment of the present disclosure includes a control unit and a communication unit. The control unit detects as an event, in a vehicle, a fact that a first object is confused with a second object, existing on the same road as the first object, and acquires event position information and an object image. The event position information is position information of the vehicle at the time when the event is detected, and the object image is an image captured from the vehicle and including the second object. The communication unit provides the object image acquired by the control unit to be presented to a driver who is driving toward a position indicated in the event position information acquired by the control unit.

A driving assistance method according to an embodiment of the present disclosure includes a step of detecting, by a control unit, as an event, in a vehicle, a fact that a first object is confused with a second object, existing on the same road as the first object, and a step of displaying, by an output unit, an image captured from the vehicle and including the second object to be presented to a driver who is driving toward the same position as the position of the vehicle when the event is detected by the control unit.

According to an embodiment of the present disclosure, it is difficult for a driver to confuse objects existing on a road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a driving assistance system according to a first embodiment;

FIG. 2 is a flowchart illustrating an operation of the driving assistance system according to the first embodiment;

FIG. 3 is a block diagram illustrating a configuration of the driving assistance system according to a second embodiment; and

FIG. 4 is a flowchart illustrating an operation of the driving assistance system according to the second embodiment.

### DETAILED DESCRIPTION OF EMBODIMENTS

Hereinafter, embodiments of the present disclosure will be described in detail with reference to drawings.

In the drawings, the same or corresponding parts are denoted by the same reference numerals. In the description of each embodiment, the descriptions of the same or corresponding parts are appropriately omitted or simplified.

### First Embodiment

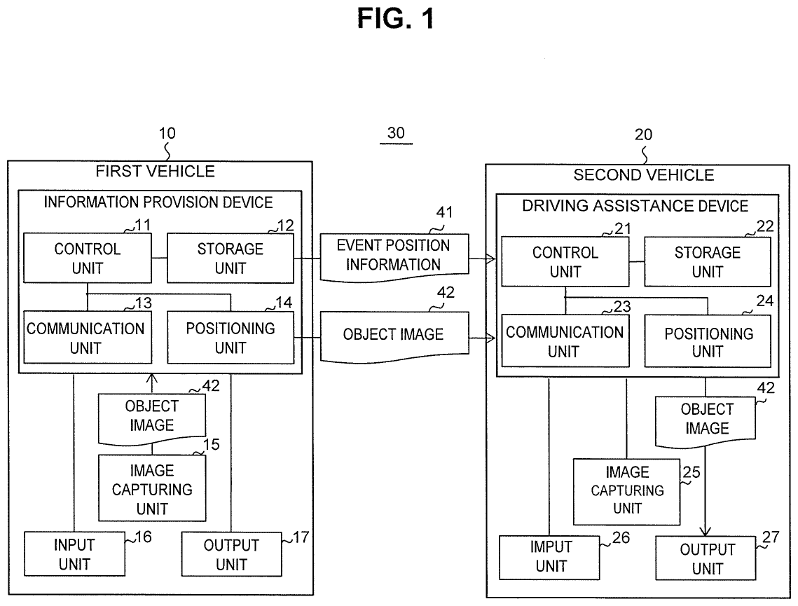

With reference to FIG. 1, an overview on the present embodiment will be described.

A control unit 11 of a first vehicle 10 detects, in the first vehicle 10, as an event, a fact that a first object is confused with a second object, existing on the same road as the first object. An output unit 27 of a second vehicle 20 that is different from the first vehicle 10 displays an image captured from the first vehicle 10 and including a second object, to be presented to a driver of the second vehicle 20 who is driving toward the same position as the position of the first vehicle 10 at the time when the event is detected by the control unit 11 of the first vehicle 10.

When the driver of the second vehicle 20 is driving toward the position where the event, in which the driver of the first vehicle 10 confuses the first object with the second object, occurs, the driver of the second vehicle 20 can visually check the appearance of the second object by looking at an object image 42 displayed by the output unit 27. Therefore, according to the present embodiment, it is difficult to make a mistake of confusing the first object with the second object. In other words, it is difficult for the driver to confuse objects existing on the road.

The object image 42 may be an image in which only the second object is captured in close-up, but in the present embodiment, the object image 42 includes surroundings of the second object. Accordingly, the driver of the second vehicle 20 can visually check what is seen in the surroundings of the second object as well as the appearance of the second object by looking at the object image 42 displayed by the output unit 27. Therefore, according to the present embodiment, it is more difficult to make the mistake of confusing the first object with the second object.

In the present embodiment, the first object and the second object are signals, branches, or intersections, but may be objects existing on the same road, or objects or places on the road or facing the road. The “object” may include various objects from a small object, such as a sign, to a big object, such as a building.

The first vehicle 10 and the second vehicle 20 may be any vehicles, but in the present embodiment, both are automobiles. The relationship between the first vehicle 10 and the second vehicle 20 is not limited to a one-to-one relationship, and may be any of a one-to-many, a many-to-one, or a many-to-many relationship.

With reference to FIG. 1, a configuration of a driving assistance system 30 according to the present embodiment will be described.

A driving assistance system 30 includes an information provision device 31 and a driving assistance device 32.

The information provision device 31 is provided in the first vehicle 10. The information provision device 31 may include in-vehicle equipment, such as a navigation device, or electronic equipment used by being connected to the in-vehicle equipment, such as a smartphone.

The information provision device 31 includes constituent elements, such as a control unit 11, a storage unit 12, a communication unit 13, and a positioning unit 14.

The control unit 11 includes one or more processors. As the processor, a general-purpose processor, such as a CPU and a processor dedicated to a specific process may be used. The “CPU” is an abbreviation for a central processing unit. One or more dedicated circuits may be included in the control unit 11, or may replace one or more processors in the control unit 11. As the dedicated circuit, for example, an FPGA or an ASIC may be used. The “FPGA” is an abbreviation for a field-programmable gate array. The “ASIC” is an abbreviation for an application specific integrated circuit. The control unit 11 may include one or one more ECUs. The “ECU” is an abbreviation for an electronic control unit. The control unit 11 performs information processing associated with the operation of the information provision device 31 while controlling each unit of the first vehicle 10 including the information provision device 31.

The storage unit 12 includes one or more memories. As the memory, for example, a semiconductor memory, a magnetic memory, or an optic memory may be used. The memory may function as a primary storage device, a secondary storage device, or a cache memory. The storage unit 12 stores information used for the operation of the information provision device 31 and information obtained by the operation of the information provision device 31.

The communication unit 13 includes one or more communication modules. As the communication module, for example, a communication module corresponding to a DSRC, LTE, 4G, or 5G may be used. The “DSRC” is an abbreviation for dedicated short range communications. The “LTE” is an abbreviation for long term evolution. The “4G” is an abbreviation for 4th generation. The “5G” is an abbreviation for 5th generation. The communication unit 13 receives information used for the operation of the information provision device 31, and transmits information obtained by the operation of the information provision device 31.

The positioning unit 14 includes one or more positioning modules. As the positioning module, for example, a positioning module corresponding to a GPS, a QZSS, a GLONASS, or a Galileo may be used. The “GPS” is an abbreviation for global positioning system. The “QZSS” is an abbreviation for quasi-zenith satellite system. The QZSS satellite is called the quasi-zenith satellite. The “GLONASS” is an abbreviation for global navigation satellite system. The positioning unit 14 acquires position information of the first vehicle 10.

The function of the information provision device 31 is implemented by running the information provision program according to the present embodiment by the processor included in the control unit 11. In other words, the function of the information provision device 31 is implemented by software. By causing a computer to perform processing of a step included in the operation of the information provision device 31, the information provision program causes the computer to implement a function corresponding to the processing of the step. In other words, the information provision program causes the computer to function as the information provision device 31.

The program can be recorded on a computer-readable recording medium. As the computer-readable recording medium, for example, a magnetic recording device, an optical disk, a magneto-optical recording medium, or a semiconductor memory may be used. The program is distributed, for example, by selling, transferring, or lending a portable recording medium, such as a DVD and a CD-ROM in which the program is recorded. The “DVD” is an abbreviation for digital versatile disc. The “CD-ROM” is an abbreviation for compact disc read-only memory. The program may be distributed by storing the program in a storage of a server, and transmitting the program from the server to another computer via a network. The program may be provided as a program product.

For example, the computer temporarily stores, in the memory, the program recorded on a portable recording medium or the program transmitted from the server. Then, the computer reads the program stored in the memory by the processor, and performs processing by the processor according to the read program. The computer may read the program directly from the portable recording medium and perform the processing according to the program. The computer may sequentially perform the processing according to the received program each time the program is transmitted from the server to the computer. The process may be performed by a so-called ASP-type service that implements the function only by a performance instruction and a result acquisition without the program transmitted from the server to the computer. The “ASP” is an abbreviation for application service provider. The program includes information that is used for processing by an electronic calculator and that is equivalent to the program. For example, data that is not a direct command to a computer but has a property that regulates the processing of the computer corresponds to “an equivalent to a program”.

Part or all of the functions of the information provision device 31 may be implemented by a dedicated circuit included in the control unit 11. In other words, part or all of the functions of the information provision device 31 may be implemented by hardware.

In addition to the information provision device 31, the first vehicle 10 includes an image capturing unit 15, an input unit 16, and an output unit 17. In the first vehicle 10, the image capturing unit 15, the input unit 16, and the output unit 17 may be part of the information provision device 31.

The image capturing unit 15 includes one or more in-vehicle cameras. As the in-vehicle camera, for example, a front camera, a side camera, a rear camera, or an inside-vehicle camera may be used. The image capturing unit 15 captures an image from the first vehicle 10. In other words, the image capturing unit 15 captures an image outside the first vehicle 10. The image capturing unit 15 also captures an image inside the first vehicle 10, such as the driver's seat of the first vehicle 10.

The input unit 16 includes one or more input interfaces. As the input interface, for example, a physical key, a capacitive key, a pointing device, a touch screen integrally installed with an in-vehicle display, or an in-vehicle microphone may be used. The input unit 16 receives an input of information used for the operation of the information provision device 31 from a user, such as the driver of the first vehicle 10.

The output unit 17 includes one or more output interfaces. As the output interface, for example, an in-vehicle display or an in-vehicle speaker may be used. As the in-vehicle display, for example, an LCD or an organic EL display may be used. The “LCD” is an abbreviation for liquid crystal display. The “EL” is an abbreviation for electro-luminescence. The output unit 17 outputs, to the user, the information obtained by the operation of the information provision device 31.

The driving assistance device 32 is provided in the second vehicle 20. The driving assistance device 32 may include the in-vehicle equipment, such as the navigation device, or the electronic equipment used by being connected to the in-vehicle equipment, such as the smartphone.

The driving assistance device 32 includes constituent elements, such as a control unit 21, a storage unit 22, a communication unit 23, and a positioning unit 24.

The control unit 21 includes one or more processors. As the processor, a general-purpose processor, such as a CPU, or a processor dedicated to a specific process may be used. One or more dedicated circuits may be included in the control unit 21, or may replace one or more processors in the control unit 21. As the dedicated circuit, for example, an FPGA or an ASIC may be used. The control unit 21 may include one or one more ECUs. The control unit 21 performs information processing associated with the operation of the driving assistance device 32 while controlling each unit of the second vehicle 20 including the driving assistance device 32.

The storage unit 22 includes one or more memories. As the memory, for example, a semiconductor memory, a magnetic memory, or an optic memory may be used. The memory may function as a primary storage device, a secondary storage device, or a cache memory. The storage unit 22 stores information used for the operation of the driving assistance device 32 and information obtained by the operation of the driving assistance device 32.

The communication unit 23 includes one or more communication modules. As the communication module, for example, a communication module corresponding to a DSRC, LTE, 4G, or 5G may be used. The communication unit 23 receives information used for the operation of the driving assistance device 32, and transmits information obtained by the operation of the driving assistance device 32.

The positioning unit 24 includes one or more positioning modules. As the positioning module, for example, a positioning module corresponding to a GPS, a QZSS, a GLONASS, or a Galileo may be used. The positioning unit 24 acquires positioning information of the second vehicle 20.

The function of the driving assistance device 32 is implemented by running the driving assistance program according to the present embodiment by the processor included in the control unit 21. In other words, the function of the driving assistance device 32 is implemented by software. By causing a computer to perform processing of a step included in the operation of the driving assistance device 32, the driving assistance program causes the computer to implement a function corresponding to the processing of the step. In other words, the driving assistance program causes the computer to function as the driving assistance device 32.

Part or all of the functions of the driving assistance device 32 may be implemented by a dedicated circuit included in the control unit 21. In other words, part or all of the functions of the driving assistance device 32 may be implemented by hardware.

In addition to the driving assistance device 32, the second vehicle 20 includes an image capturing unit 25, an input unit 26, and an output unit 27. In the second vehicle 20, the image capturing unit 25, the input unit 26, and the output unit 27 may be part of the driving assistance device 32.

The image capturing unit 25 includes one or more in-vehicle cameras. As the in-vehicle camera, for example, a front camera, a side camera, a rear camera, or an inside-vehicle camera may be used. The image capturing unit 25 captures an image from the second vehicle 20. In other words, the image capturing unit 25 captures an image outside the second vehicle 20. The image capturing unit 25 also captures an image inside the second vehicle 20, such as the driver's seat of the second vehicle 20.

The input unit 26 includes one or more input interfaces. As the input interface, for example, a physical key, a capacitive key, a pointing device, a touch screen integrally installed with an in-vehicle display, or an in-vehicle microphone may be used. The input unit 26 receives an input of information used for the operation of the driving assistance device 32 from a user, such as the driver of the second vehicle 20.

The output unit 27 includes one or more output interfaces. As the output interface, for example, an in-vehicle display or an in-vehicle speaker may be used. As the in-vehicle display, for example, an LCD or an organic EL display may be used. The output unit 27 outputs, to the user, the information obtained by the operation of the driving assistance device 32.

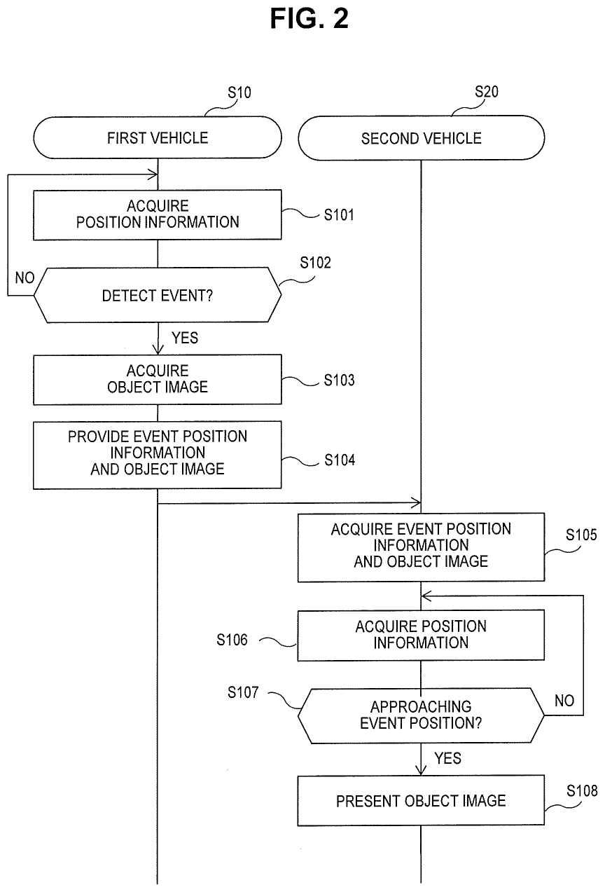

In addition to FIG. 1, with reference to FIG. 2, the operation of the driving assistance system 30 according to the present embodiment will be described. The operation of the driving assistance system 30 corresponds to a driving assistance method according to the present embodiment.

The processing of steps S101 to S104 is performed by the first vehicle 10.

In step S101, the control unit 11 of the information provision device 31 acquires position information of the first vehicle 10.

Specifically, the control unit 11 acquires, from the positioning unit 14, the position information of the first vehicle 10 at the current time. Examples of the position information may include two-dimensional coordinates or three-dimensional coordinates of the current position of the first vehicle 10 obtained by using the GPS, the QZSS, the GLONASS, the Galileo, or a combination of two or more thereof.

In step S102, the control unit 11 detects, in the first vehicle 10, as an event Eₐ, an event E_{b}, or an event E_{c}, the fact that the first object is confused with the second object, existing on the same road Rₓ as the first object.

When the second object is a signal A2 to be followed at the position of the first vehicle 10 and the first object is a signal A1 that is different from A2, the event Eₐ is an event in which the driver of the first vehicle 10 confuses the signal A1 with the signal A2. The event Eₐ may occur when, for example, the signal A1 and the signal A2 are lined up in a travel direction of the first vehicle 10 or when the signal A1 and the signal A2 are facing a similar direction at a complicated intersection.

The control unit 11 determines whether or not the event Eₐ has occurred depending on whether the behavior of the first vehicle 10 conforms to the lighting state of the signal A2 or the lighting state of the signal A1.

Specifically, the control unit 11 determines whether or not the current position of the first vehicle 10 indicated in the position information acquired in step S101 is within a range Nₓ. The range Nₓ is a position range of the first vehicle 10 where a situation, in which the driver of the first vehicle 10 should drive according to the signal A2 but confuses the signal A1 with the signal A2 and drives according to the signal A1, may occur. For example, a position range where both the signal A1 and the signal A2 can be seen simultaneously may be set as the range Nₓ for the sake of convenience. When the current position of the first vehicle 10 is not within the range Nₓ, the control unit 11 determines that the event Eₐ has not occurred. When the current position of the first vehicle 10 is within the range Nₓ, the control unit 11 sequentially acquires subsequent position information of the first vehicle 10 from the positioning unit 14, and sequentially acquires, from the image capturing unit 15, an image including the signal A1 and the signal A2, such as an image ahead of the first vehicle 10. The control unit 11 determines the behavior of the first vehicle 10, such as moving forward, turning left, turning right, and stopping, according to a change in a position indicated in the acquired position information. At the same time, the control unit 11 analyzes the acquired image and determines the lighting state, such as the lighting color of each of the signal A1 and the signal A2, the direction of the arrow if there is an arrow on the signal A1 and the signal A2, and whether a light is blinking. As a technology for recognizing the lighting state of a signal in an image, for example, an image recognition technology based on machine learning may be used. The control unit 11 determines whether the behavior of the first vehicle 10 conforms to the lighting state of the signal A2 based on a determination result of the behavior of the first vehicle 10 and the lighting state of the signal A2. When the behavior of the first vehicle 10 follows the lighting state of the signal A2, the control unit 11 determines that the event Eₐ has not occurred. When the behavior of the first vehicle 10 does not follow the lighting state of the signal A2, the control unit 11 determines whether the behavior of the first vehicle 10 follows the lighting state of the signal A1 based on a determination result of the behavior of the first vehicle 10 and the lighting state of the signal A1. When the behavior of the first vehicle 10 does not follow the lighting state of the signal A1, the control unit 11 determines that the event Eₐ has not occurred. When the behavior of the first vehicle 10 follows the lighting state of the signal A1, the control unit 11 determines that the event Eₐ has occurred. For example, when the light of the signal A2 is red, the light of the signal A1 is green, and the first vehicle 10 is moving forward, the control unit 11 determines that the event Eₐ has occurred.

In the present embodiment, the signal A1, the signal A2, and the range Nₓ are defined in advance. However, the control unit 11 may dynamically specify the signal A1, the signal A2, and the range Nₓ based on a positional relationship between the first vehicle 10 and a group of signals around the first vehicle 10 each time the control unit 11 acquires the position information of the first vehicle 10 from the positioning unit 14. The position of the signal group around the first vehicle 10 is specified based on, for example, map information.

When determining that the behavior of the first vehicle 10 does not follow the lighting state of the signal A2, the control unit 11 may output a message to alert the driver of the first vehicle 10 via the output unit 17 regardless of whether or not the event Eₐ has occurred. The message may be displayed or output in the form of audio.

The control unit 11 may determine whether or not the event Eₐ has occurred depending on whether the line of sight of the driver of the first vehicle 10 is directed at the signal A2 or the signal A1.

In that case, specifically, the control unit 11 determines whether or not the current position of the first vehicle 10 indicated in the position information acquired in step S101 is within the range Nₓ. When the current position of the first vehicle 10 is not within the range Nₓ, the control unit 11 determines that the event Eₐ has not occurred. When the current position of the first vehicle 10 is within the range Nₓ, the control unit 11 sequentially acquires subsequent position information of the first vehicle 10 from the positioning unit 14, and sequentially acquires the image including the head and the eyes of the driver of the first vehicle 10, such as an image of the driver's seat of the first vehicle 10, from the image capturing unit 15. The control unit 11 calculates the relative direction of each of the signal A1 and the signal A2 from the first vehicle 10, using the acquired position information and the map information that is stored in advance in the storage unit 12 and that indicates each of the positions of the signal A1 and the signal A2. At the same time, the control unit 11 analyzes the acquired image and calculates the direction of the line of sight of the driver of the first vehicle 10. Any well-known technology can be used as a technology for calculating the direction of the line of sight from an image including the head and the eyes of a person. The control unit 11 determines whether the sight of the driver of the first vehicle 10 is directed to the signal A2 based on a calculation result of the relative direction at the signal A2 from the first vehicle 10 and the direction of the sight of the driver of the first vehicle 10. When the sight of the driver of the first vehicle 10 is directed at the signal A2, the control unit 11 determines that the event Eₐ has not occurred. When the sight of the driver of the first vehicle 10 is not directed at the signal A2, the control unit 11 determines whether the sight of the driver of the first vehicle 10 is directed at the signal A1 based on a calculation result of the relative direction to the signal A1 from the first vehicle 10 and the direction of the sight of the driver of the first vehicle 10. When the sight of the driver of the first vehicle 10 is not directed at the signal A1, the control unit 11 determines that the event Eₐ has not occurred. When the sight of the driver of the first vehicle 10 is directed at the signal A1, the control unit 11 determines that the event Eₐ has occurred.

When determining that the sight of the driver of the first vehicle 10 is not directed at the signal A2, the control unit 11 may output a message to alert the driver of the first vehicle 10 via the output unit 17 regardless of whether or not the event Eₐ has occurred. The message may be displayed or output in the form of audio.

When the second object is a branch B2 at which the first vehicle 10 should enter a road R_{y} different from a road Rₓ in a travel route of the first vehicle 10 set by the navigation function, and the first object is a branch B1 that is different from the branch B2, the event E_{b} is an event in which the driver of the first vehicle 10 confuses the branch B1 with the branch B2. The event E_{b} may occur, for example, on a highway when guidance on the branch B2 is performed by the navigation function at a point one kilometer before the branch B2, and the branch B1 is present between the point and the branch B2.

The control unit 11 determines whether or not the event E_{b} has occurred depending on whether the first vehicle 10 has exited the road Rₓ at the branch B2 or at the branch B1.

Specifically, the control unit 11 determines whether or not the current position of the first vehicle 10 is at or near the branch B1 by combining the position information acquired in step S101 with the map information that is stored in the storage unit 12 in advance and indicates the position of the branch B1. When the current position of the first vehicle 10 is not at or near the branch B1, the control unit 11 determines that the event E_{b} has not occurred. When the current position of the first vehicle 10 is at or near the branch B1, the control unit 11 determines whether the first vehicle 10 has deviated from the set travel route by combining the position information acquired in step S101 with route information that is stored in the storage unit 12 and indicates the travel route set by the navigation function. When the first vehicle 10 has not deviated from the set travel route, the control unit 11 determines that the event E_{b} has not occurred. When the first vehicle 10 has deviated from the set travel route, the control unit 11 determines that the event E_{b} has occurred. For example, when the road Rₓ is a highway and the first vehicle 10 exits the highway at the branch B1 that is before the branch B2, the control unit 11 determines that the event E_{b} has occurred.

In the present embodiment, the branch B1 is defined in advance as a branch that is easily confused with a specific branch B2. However, the control unit 11 may dynamically specify the branch B1 based on a position relationship between the branch B2 and a group of branches around the branch B2 when a route for entering the road R_{y} from the road Rₓ at the branch B2 is set by the navigation function. The position of the group of branches around the branch B2 is specified based on, for example, the map information.

When determining that the first vehicle 10 has deviated from the set travel route, the control unit 11 may output a message to alert the driver of the first vehicle 10 via the output unit 17 regardless of whether or not the event E_{b} has occurred. The message may be displayed or output in the form of audio.

When determining that the first vehicle 10 has deviated from the set travel route, the control unit 11 may reset the travel route of the first vehicle 10 by the navigation function.

When the second object is an intersection C2 at which the first vehicle 10 should enter the road R_{y} different from the road Rₓ in the travel route of the first vehicle 10 set by the navigation function, and the first object is an intersection C1 that is different from the intersection C2, the event E_{c} is an event in which the driver of the first vehicle 10 confuses the intersection C1 with the intersection C2. The event E_{c} may occur, for example, on a local road when guidance on the intersection C2 is performed by the navigation function at a point 300 meters before the intersection C2, and the intersection C1 is present between the point and the intersection C2.

The processing for detecting the event E_{c} is the same as the processing for detecting the event E_{b} except that the branch B1 and the branch B2 are replaced with the intersection C1 and the intersection C2, respectively, and thus the description thereof is omitted. For example, when the road Rₓ intersects the road R_{y} at the intersection C2, and intersects with a different road R_{z} at the intersection C1 that is before the intersection C2, and the first vehicle 10 turns right or left at the intersection C1 and enters the road R_{z}, the control unit 11 determines that the event E_{c} has occurred.

When detecting the event Eₐ, the event E_{b}, or the event E_{c}, the control unit 11 acquires the event position information 41 in step S101. The event position information 41 is position information of the first vehicle 10 when the event Eₐ, the event E_{b}, or the event E_{c} is detected.

When the control unit 11 has detected the event Eₐ, the event E_{b}, or the event E_{c}, the process after step S103 is performed.

In step S103, the control unit 11 acquires the object image 42. The object image 42 is an image captured from the first vehicle 10 and including the second object.

Specifically, when the event detected in step S102 is the event Eₐ, the image capturing unit 15 captures, under the control of the control unit 21, an image including the signal A2, such as an image ahead of the first vehicle 10, as the object image 42. When the event detected in step S102 is the event E_{b}, the image capturing unit 15 captures, under the control of the control unit 21, an image including the branch B2, such as an image ahead of the first vehicle 10, as the object image 42. When the event detected in step S102 is the event E_{c}, the image capturing unit 15 captures, under the control of the control unit 21, an image including the intersection C2, such as an image ahead of the first vehicle 10, as the object image 42. The control unit 11 acquires the captured object image 42 from the image capturing unit 15. The control unit 11 stores the acquired object image 42 in the storage unit 12, and stores the position information acquired in step S101 in the storage unit 12 as the event position information 41 corresponding to the object image 42.

When the image acquired from the image capturing unit 15 in order to detect the event in step S102 can be used as the object image 42, the control unit 11 does not have to newly acquire the object image 42 from the image capturing unit 15. Specifically, when the event detected in step S102 is the event Eₐ, the control unit 11 may use, as the object image 42, the image acquired from the image capturing unit 15 in step S102 and including the signal A2.

The control unit 11 may perform processing, such as a cutout, upscaling and downscaling, and a resolution change, on the object image 42 acquired from the image capturing unit 15, and then store the processed object image 42 in the storage unit 12.

In step S104, the communication unit 13 of the information provision device 31 provides the object image 42 acquired by the control unit 11 to present the acquired object image 42 to the driver of the second vehicle 20 who is driving toward the position indicated in the event position information 41 acquired by the control unit 11.

Specifically, the control unit 11 inputs, into the communication unit 13, the object image 42 stored in the storage unit 12 and the event position information 41 corresponding to the object image 42 and stored in the storage unit 12. The communication unit 13 transmits, to the driving assistance device 32 of the second vehicle 20, the object image 42 and the event position information 41 that are input from the control unit 11 using inter-vehicle communication, road-to-vehicle communication, or communication via the network.

The communication unit 13 may provide the object image 42 and the event position information 41 via a server belonging to a cloud computing system or another computing system.

The processing of steps S105 to S108 is performed by the second vehicle 20.

In step S105, the communication unit 23 of the driving assistance device 32 acquires the object image 42 and the event position information 41 that are provided from the information provision device 31 of the first vehicle 10.

Specifically, the communication unit 23 receives the object image 42 and the event position information 41 that are transmitted from the information provision device 31 of the first vehicle 10 using the inter-vehicle communication, the road-to-vehicle communication, or the communication via the network. The control unit 21 acquires, from the communication unit 23, the object image 42 and the event position information 41 that are received by the communication unit 23. The control unit 21 stores the acquired object image 42 in the storage unit 22, and stores, in the storage unit 22, the acquired event position information 41 in association with the object image 42.

In step S106, the control unit 21 of the driving assistance device 32 acquires the position information of the second vehicle 20.

Specifically, the control unit 21 acquires, from the positioning unit 24, the position information of the second vehicle 20 at the current time. Examples of the position information may include two-dimensional coordinates or three-dimensional coordinates of the current position of the second vehicle 20 obtained by using the GPS, the QZSS, the GLONASS, the Galileo, or a combination of two or more thereof.

In step S107, the control unit 21 determines whether the driver of the second vehicle 20 is driving toward the position indicated in the event position information 41 acquired by the communication unit 23. In other words, the control unit 21 determines whether or not the second vehicle 20 is approaching the position indicated in the event position information 41.

Specifically, the control unit 21 calculates a distance between the current position of the second vehicle 20 indicated in the position information acquired in step S106 and the position indicated in the event position information 41 stored in the storage unit 22. The control unit 21 compares the calculated distance with a threshold. The threshold may be a fixed value, such as 300 m, or a value that is dynamically obtained according to a speed limit of the road Rₓ or the speed of the second vehicle 20. In the case of the fixed value, the threshold may be selected according to a type of the road Rₓ, such as 300 m when the road Rₓ is a local road and 1 km when the road Rx is a highway. When the calculated distance is greater than the threshold, the control unit 21 determines that the second vehicle 20 is not approaching the position indicated in the event position information 41. When the calculated distance is smaller than the threshold, the control unit 21 determines that the second vehicle 20 is approaching the position indicated in the event position information 41, that is, the driver of the second vehicle 20 is driving toward the position indicated in the event position information 41.

The event position information 41 may include information indicating the travel direction of the first vehicle 10 at the time when the event Eₐ, the event E_{b}, or the event E_{c} is detected. In that case, the control unit 21 determines the travel direction of the second vehicle 20 according to a change in the position indicated in the position information that is acquired in step S106. When the calculated distance is smaller than the threshold and the determined travel direction is the same as the travel direction indicated in the event position information 41, the control unit 21 determines that the second vehicle 20 is approaching the position indicated in the event position information 41.

When the control unit 21 determines that the second vehicle 20 is approaching the position indicated in the event position information 41, the processing of step S108 is performed.

In step S108, the control unit 21 of the driving assistance device 32 presents the object image 42 acquired by the communication unit 23 to the driver of the second vehicle 20. The control unit 21 uses the output unit 27 as a medium for presenting the object image 42. In other words, the output unit 27 displays, under the control of the control unit 21, the object image 42 acquired by the communication unit 23 to present the acquired object image 42 to the driver of the second vehicle 20.

Specifically, the control unit 21 inputs, into the output unit 27, the object image 42 stored in the storage unit 22. The output unit 27 displays a screen including the object image 42 input from the control unit 21. On the screen, the names of the intersection corresponding to the signal A2, the branch B2, or the intersection C2 may be displayed as characters, or a symbol, such as an icon, is displayed at the position of the signal A2, the branch B2, or the intersection C2 on the map. A symbol, such as another icon, may also be displayed at the current position of the second vehicle 20 on the same map. The amount of information on the screen is appropriately adjusted so as to not hinder safe driving. For example, the names of the intersection corresponding to the signal A2, the branch B2, or the intersection C2 may be output in the form of audio instead of being displayed as characters.

The length of time for which the screen including the object image 42 is displayed may be fixed to, for example, 30 seconds, or dynamically determined according to the position of the second vehicle 20. When the length of time is dynamically determined according to the position of the second vehicle 20, the screen including the object image 42 may be displayed until the second vehicle 20 passes through the intersection corresponding to the signal A2, the branch B2, or the intersection C2, or until the second vehicle 20 reaches the position indicated in the event position information 41.

As described above, in the present embodiment, the control unit 11 of the information provision device 31 detects, in the first vehicle 10, as the event Eₐ, the event E_{b}, or the event E_{c}, the fact that the first object is confused with the second object existing on the same road Rₓ as the first object. The control unit 11 acquires the event position information 41 that is the position information of the first vehicle 10 at the time when the event Eₐ, the event E_{b}, or the event E_{c} is detected, and the object image 42 captured from the first vehicle 10 and including the second object. The communication unit 13 of the information provision device 31 provides the object image 42 acquired by the control unit 11 to present the acquired object image 42 to the driver of the second vehicle 20 who is driving toward the position indicated in the event position information 41 acquired by the control unit 11. The control unit 21 of the driving assistance device 32 acquires the event position information 41 and the object image 42. The control unit 21 presents the acquired object image 42 to the driver of the second vehicle 20 before the second vehicle 20 reaches the position indicated in the event position information 41. Therefore, according to the present embodiment, it is difficult to make a mistake of confusing the first object with the second object. In other words, it is difficult for the driver to confuse objects existing on the road.

According to the present embodiment, the driver's mistake can be certainly reduced by showing the driver the actual image of an object, such as the signal A2, the branch B2, and the intersection C2 before the point where the mistake may occur. As a result, traffic safety is improved.

The control unit 21 of the driving assistance device 32 does not have to present the object image 42 to the driver of the second vehicle 20 when the second vehicle 20 is in fully autonomous driving mode. The fully autonomous driving mode corresponds to “level 5” in an SAE level classification, but may include “level 4” or an autonomous driving level according to another definition. The “SAE” is an abbreviation for Society of Automotive Engineers.

The information provision device 31 may include a server belonging to a cloud computing system or other computing system. In that case, the processing of steps S101 to S104 is performed by the server. Information necessary for processing of steps S101 to S104, such as the position information of the first vehicle 10, the image ahead of the first vehicle 10, the image of the driver's seat of the first vehicle 10, and the route information of the first vehicle 10, may be uploaded from the first vehicle 10 to the server. The object image 42 and the event position information 41 may be delivered from the server to the second vehicle 20.

### Second Embodiment

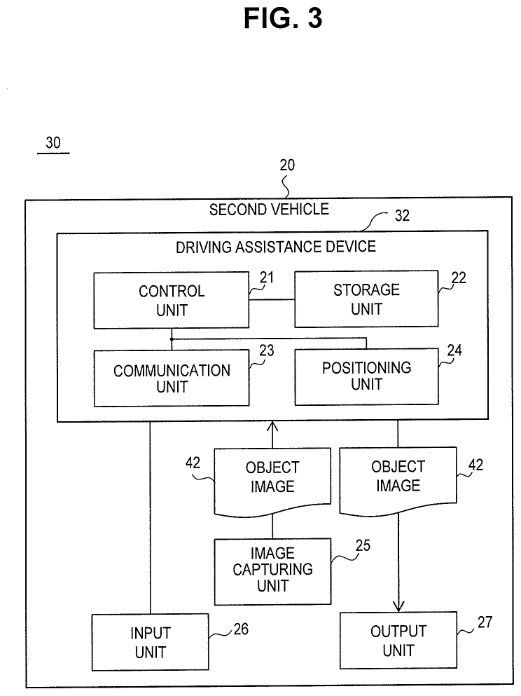

With reference to FIG. 3, an overview of the present embodiment will be described.

In the first embodiment, the control unit 11 of the first vehicle 10 detects, in the first vehicle 10, as an event, the fact that the first object is confused with the second object, existing on the same road as the first object. On the other hand, the control unit 21 of the second vehicle 20 detects, in the second vehicle 20, as an event, the fact that the first object is confused with the second object, existing on the same road as the first object. The output unit 27 of the second vehicle 20 displays the image captured from the second vehicle 20 and including the second object to present the image to the driver of the second vehicle who is driving toward the same position as the position of the second vehicle 20 when the event is detected by the control unit 21.

When driving toward the position where the event, in which the driver of the second vehicle 20 confuses the first object with the second object, has occurred, the driver of the second vehicle 20 can visually check the appearance of the second object by looking at the object image 42 displayed on the output unit 27. Therefore, according to the present embodiment, it is difficult to make a mistake of confusing the first object with the second object again. In other words, it is difficult for the driver to confuse objects existing on the road.

Contrary to the first embodiment, since the first vehicle 10 is unnecessary, the second vehicle 20 may be simply referred to as a “vehicle”.

With reference to FIG. 3, a configuration of a driving assistance system 30 according to the present embodiment will be described. The descriptions on parts in common with the first embodiment is appropriately omitted or simplified.

The driving assistance system 30 includes a driving assistance device 32. The driving assistance system 30 does not have to include the information provision device 31 as in the first embodiment.

As in the first embodiment, the driving assistance device 32 is provided in the second vehicle 20.

As in the first embodiment, other than the driving assistance device 32, the second vehicle 20 includes an image capturing unit 25, an input unit 26, and an output unit 27.

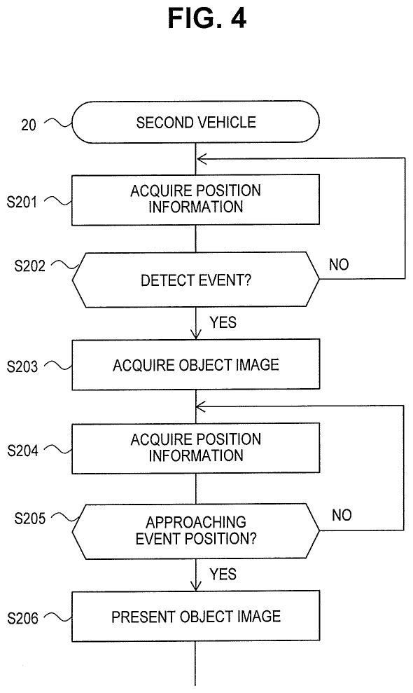

Other than FIG. 3, with reference to FIG. 4, the operation of the driving assistance system 30 according to the present embodiment will be described. The description on parts in common with the first embodiment is appropriately omitted or simplified. The operation of the driving assistance system 30 corresponds to a driving assistance method according to the present embodiment.

The processing of steps S201 to S206 is performed by the second vehicle 20.

The processing of steps S201 to S203 is the same as the processing of steps S101 to S103 except that the first vehicle 10, and the control unit 11, the storage unit 12, the positioning unit 14, and the image capturing unit 15 of the information provision device 31 are replaced with the second vehicle 20, and the control unit 21, the storage unit 22, the positioning unit 24, and the image capturing unit 25 of the driving assistance device 32, respectively, and thus the description thereof is omitted.

The processing of step S204 is the same as the processing of step S106, and thus the description thereof is omitted.

The processing of step S205 is the same as the processing of step S107, except that, in step S205, the position information acquired inside the second vehicle 20 in step S201 is used as the event position information 41, instead of the position information received from the outside of the second vehicle 20, and thus the description thereof is omitted.

The processing of step S206 is the same as the processing of step S108, except that, in step S206, the image acquired inside the second vehicle 20 in step S203 is used as the object image 42, instead of the image received from the outside of the second vehicle 20, and thus the description thereof is omitted.

Instead of storing the acquired event position information 41 and the acquired object image 42 in the storage unit 22, the control unit 21 stores the event position information 41 and the object image 42 in a storage external to the second vehicle 20, such as a cloud storage, and may acquire and use them via the communication unit 23.

As described above, in the present embodiment, the control unit 21 of the driving assistance device 32 detects, in the second vehicle 20, as the event Eₐ, the event E_{b}, or the event E_{c}, the fact that the first object is confused with the second object, existing on the same road Rₓ as the first object. The control unit 21 acquires the event position information 41 that is the position information of the second vehicle 20 at the time when the event Eₐ, the event E_{b}, or the event E_{c} is detected, and the object image 42 including the second object, which is captured from the second vehicle 20. The control unit 21 presents the acquired object image 42 to the driver of the second vehicle 20 at the time different from the time when the event Eₐ, the event E_{b}, or the event E_{c} is detected and before the second vehicle 20 reaches the position indicated in the event position information 41. For example, after the event Eₐ occurs in the second vehicle 20 and a certain period of time elapses, when the second vehicle 20 tries to travel again the point where the event Eₐ has occurred, the control unit 21 presents the object image 42 obtained at the time of occurrence of the event Eₐ to the driver of the second vehicle 20. Therefore, according to the present embodiment, it is difficult to make a mistake of confusing the first object with the second object again. In other words, it is difficult for the driver to confuse objects existing on the road.

The present disclosure is not limited to the embodiments described above. For example, a plurality of blocks illustrated in the block diagram may be integrated, or one of the plurality of blocks may be divided. Instead of performing a plurality of steps described in the flowchart in time series according to the description, the steps may be performed according to the processing capability of a device that performs each step, in parallel as necessary, or in a different order. Other variations may be made within the technical scope of the disclosure.

What is claimed is:

1. A driving assistance device comprising:
a control unit configured to:
acquire event position information and an object image, wherein the event position information is position information of a vehicle at a time when a fact that a first object is confused with a second object, existing on the same road as the first object, is detected as an event in the vehicle, and the object image is an image captured from the vehicle and including the second object, and
present the acquired object image to a driver who is driving toward a position indicated in the acquired event position information.

2. The driving assistance device according to claim 1, wherein the control unit is configured to, before a vehicle different from the vehicle reaches the position indicated in the event position information, present the object image to a driver of the different vehicle.

3. The driving assistance device according to claim 1, wherein the control unit is configured to detect the event, and present the object image to the driver of the vehicle at a time different from a time when the event is detected, and before the vehicle reaches the position indicated in the event position information.

4. A vehicle comprising:
the driving assistance device according to claim 1; and
an output unit configured to display an object image.

5. An information provision device comprising:
a control unit configured to detect as an event, in a vehicle, a fact that a first object is confused with a second object existing on the same road as the first object, and acquire event position information and an object image, wherein the event position information is position information of the vehicle at a time when the event is detected, and the object image is an image captured from the vehicle and including the second object; and
a communication unit configured to provide the object image, acquired by the control unit, to be presented to a driver who is driving toward a position indicated in the event position information acquired by the control unit.

6. The information provision device according to claim 5, wherein the control unit is configured to determine whether or not the event has occurred depending on whether a behavior of the vehicle conforms to a lighting state of the second object that is a signal to be followed at a position of the vehicle, or a lighting state of the first object that is a signal different from the second object.

7. The information provision device according to claim 5, wherein the control unit is configured to determine whether or not the event has occurred depending on whether a line of sight of the driver of the vehicle is directed at the second object that is a signal to be followed at a position of the vehicle or the first object that is a signal different from the second object.

8. The information provision device according to claim 5, wherein the control unit is configured to determine whether or not the event has occurred depending on whether the vehicle has exited a road at the second object being a branch or an intersection at which the vehicle enters a road different from the road or at the first object being a branch or an intersection different from the second object, in a travel route of the vehicle set by a navigation function.

9. A vehicle comprising:
an image capturing unit configured to capture an object image; and
the information provision device according to claim 5.

10. A driving assistance system comprising:
the information provision device according to claim 5; and
a driving assistance device configured to acquire event position information and an object image from the information provision device and present the object image to a driver who is driving toward a position indicated in the event position information.

11. A driving assistance method comprising:
detecting, by a control unit, as an event, in a vehicle, a fact that a first object is confused with a second object existing on the same road as the first object; and
displaying, by an output unit, an image captured from the vehicle and including the second object to be presented to a driver who is driving toward the same position as a position of the vehicle when the event is detected by the control unit.
